(19) United States
(12) Patent Application Publication
(10) Pub. No.: US 2010/0272870 A1
(43) Pub. Date: Oct. 28, 2010

(54) Preparation method for caffeine control and device thereof

(75) Inventors: Hsien-Jung Hsu, Sinshih Township (TW); Ming-Chi Chung, Sinshih Township (TW)

Correspondence Address: Far East University, P.O. Box No. 6-57, Junghe, Taipei, 235, TW

(73) Assignee: Far East University, Sinshih Township (TW)

(21) Appl. No.: 12/385,932

(22) Filed: Apr. 24, 2009

(51) Int. Cl. A23L 1/48; A47J 31/44

(52) U.S. Cl. 426/238; 426/506; 99/288; 99/287

(57) ABSTRACT

A preparation method for caffeine control and device thereof, mainly consisting of: a. mixing coffee powder and water in a container; b. applying a vibration force to the container for an acting time, and maintaining the operating temperature during this stage within a first working temperature range; c. compressing the space within the container to cause specific components in the coffee powder to be extracted and form coffee liquid; d. heating the coffee liquid obtained from step c to a second working temperature. Accordingly, vibration extraction and compression process at the first working temperature and the further heating process at the second working temperature are used to control the caffeine content of hot coffee.

### BACKGROUND OF THE INVENTION

(a) Field of the Invention

The present invention relates to a preparation method for caffeine control and device thereof, in which a vibration extraction process is first applied to coffee powder and water at a first temperature, parameter conditions of the first temperature is used to control the amount of caffeine extracted, after which compression is applied to obtain the extracted liquid, and then the extracted liquid is heated to a second temperature.

(b) Description of the Prior Art

Current common methods for preparing coffee include Water Drip, Siphon, steam compression (Espresso) and Paper Drip, wherein the water drip method is carried out at a low temperature, and the water drip coffee (ice brewed coffee) is formed using natural water pressure seepage and adjustment of the drip speed to effect slowly trickle filtering of cold water; the drip process being carried out for a long period of approximately 10 hours at a low temperature of 5° C. (Celsius). An advantage of water drip coffee is its relatively low caffeine content, and thus does not have a bitter taste, does not harm the stomach, and because water drip coffee is prepared using a cold water trickle filtering process, thus, the coffee is hundred percent infused and saturated, and the low caffeine content results in the extracted coffee having a smooth taste which is not bitter. However, shortcomings include an excessively long preparation time. The siphon method, the steam compression method (espresso) and the paper drip method use high temperature water to assist extracting specific components from the coffee powder containing caffeine to produce coffee liquid. Coffee prepared using such methods is strong and aromatic, and time to prepare the coffee is shorter (approximately 3 to 6 minutes). However, because during the preparation process, the preparation temperature is continually maintained at a high temperature (such as 85° C.), thus, certain chemical substances in the coffee powder are also extracted, resulting in the coffee liquid easily having an astringent taste.

### SUMMARY OF THE INVENTION

The present invention proposes to resolve the problems of the bad taste of coffee prepared at a high temperature and the excessively long time required to prepare coffee at normal temperature.

The present invention discloses a preparation method for caffeine control, comprising the following steps: a. mixing coffee powder and water in a container; b. applying a vibration force to the container for an acting time, and maintaining the operating temperature during this stage within a first working temperature range; c. compressing the space within the container to cause specific components in the coffee powder to be extracted and form coffee liquid; d. heating the coffee liquid obtained from step c to a second working temperature.

In the aforementioned preparation method for caffeine control, step a is carried out at a normal temperature.

In the aforementioned preparation method for caffeine control, the vibration force of step b uses an acting force of ultrasonic vibration frequency.

In the aforementioned preparation method for caffeine control, acting time for step b is 1 to 5 minutes.

In the aforementioned preparation method for caffeine control, the first working temperature of step b is a normal temperature or a temperature between 5 to 60° C.

In the aforementioned preparation method for caffeine control, the second working temperature of step d is higher than the first working temperature of step b, and is between 80 and 100° C., the preferred temperature being 85° C.

The present invention also discloses a preparation device for caffeine control, comprising: a container, provided with a holding space and an outlet, the outlet being fitted with a valve; a vibration unit, position of which is installed to enable vibration waves to have an effect within the range of the container; a temperature control element, position of which enables heat energy to have an effect within the range of the container; and a compression element, movable within the container, and used to alter the holding space of the container.

In the aforementioned preparation device for caffeine control, the vibration unit is attached to the container.

In the aforementioned preparation device for caffeine control, the vibration unit is disposed close to the container, and a vibration wave transmission medium is disposed between the vibration unit and the container, the transmission medium being a liquid.

In the aforementioned preparation device for caffeine control, the temperature control element is attached to the container.

In the aforementioned preparation device for caffeine control, the temperature control element is disposed close to the container, and a heat energy transmission medium is disposed between the temperature control element and the container, the transmission medium being a liquid or gas.

The present invention is provided with the following functions:

1. Uses normal temperature extraction to prepare an extracted coffee liquid with low caffeine, thereby eliminating the bitter and astringent taste of high caffeine coffee.

2. Short extraction time at normal temperature, thereby avoiding an excessively long waiting time to prepare coffee.

3. Combines a normal temperature compression process to enable more complete extraction.

4. Uses ultrasonic vibration to assist extraction, thereby enabling the extraction process to be quickly carried out at a normal temperature (even low temperatures).

5. Another heating process is carried out on the coffee liquid after completing extraction, thereby heating the low caffeine coffee liquid and preparing a hot coffee liquid of low caffeine and mellow taste.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is an operation procedure chart of the method of the present invention.

FIG. 2 is a structural schematic view of the device of the present invention.

FIG. 3 is a first implementation schematic view of the device of the present invention.

FIG. 4 is a second implementation schematic view of the device of the present invention.

FIG. 5 is a comparison table comparing the caffeine concentration contained in the coffee prepared using the method of the present invention whereby vibration is applied to coffee powder and water at various temperatures for 15 seconds and 30 seconds and coffee brewed at the traditional high temperature.

FIG. 6 is a graph comparing the caffeine concentration contained in the coffee prepared using the method of the present invention whereby vibration is applied to coffee powder and water at various temperatures for 15 seconds and 30 seconds and coffee brewed at the traditional high temperature.

### DETAILED DESCRIPTION OF THE PREFERRED EMBODIMENTS

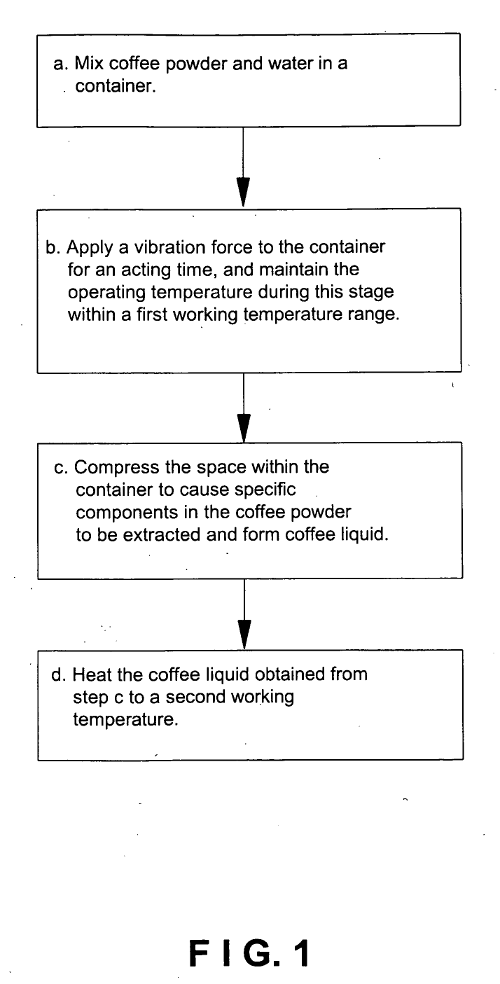

Referring to FIG. 1, the present invention discloses a preparation method for caffeine control, comprising the following steps:

a. Mixing coffee powder and water in a container; this step primarily consisting of placing ground coffee together with an appropriate proportion of water into the container, and maintaining the working temperature of the container at a normal temperature.

b. Applying a vibration force to the container for an acting time, and maintaining the operating temperature during this stage within a first working temperature range; this step primarily consisting of applying ultrasonic vibration to the container, and the ultrasonic vibration period is maintained for 1 to 5 minutes, while the working temperature is maintained at a normal temperature or controlled within a 5 to 60° C. range. Vibration of ultrasonic waves is used to assist the extraction process. In addition, extraction is carried out at a ‘non-high temperature’ (lower than 85° C.), thereby enabling extraction of the aromatic components of the coffee powder, while preventing a large amount of caffeine from being extracted.

c. Compressing the space within the container to cause specific components in the coffee powder to be extracted and form coffee liquid; this step primarily consisting of compressing the original holding space of the container, whereby compression is used to enable specific components containing low quantities of caffeine in the coffee powder to be extracted, thereby obtaining coffee liquid. The working temperature is at a normal temperature or is controlled to be within a 5 to 60° C. range.

d. Heating the coffee liquid obtained from step c to a second working temperature; this step primarily consisting of heating the coffee liquid of the previous step, whereby the temperature of the coffee liquid is raised from a normal temperature to a high temperature, the value of which is between 80 and 100° C., 85° C. being the preferred temperature. This procedural step causes the coffee liquid to be in a hot state, retaining low caffeine but providing a better taste.

Through the aforementioned steps, the specific components of the coffee are effectively extracted at a normal temperature and within a short time, after which a high temperature heating procedure is carried out on the extracted coffee liquid, thereby obtaining low caffeine coffee liquid that does not contain an acid taste or bitter taste.

In the aforementioned step b, applying a vibration force enables assisting effective extraction of the aromatic components, and controlling the vibration time and first temperature parameters enables controlling the amount of caffeine extracted. When the first temperature is relatively low, the extracted caffeine component is comparatively less, and when the first temperature is relatively high, then the extracted caffeine component is comparatively more.

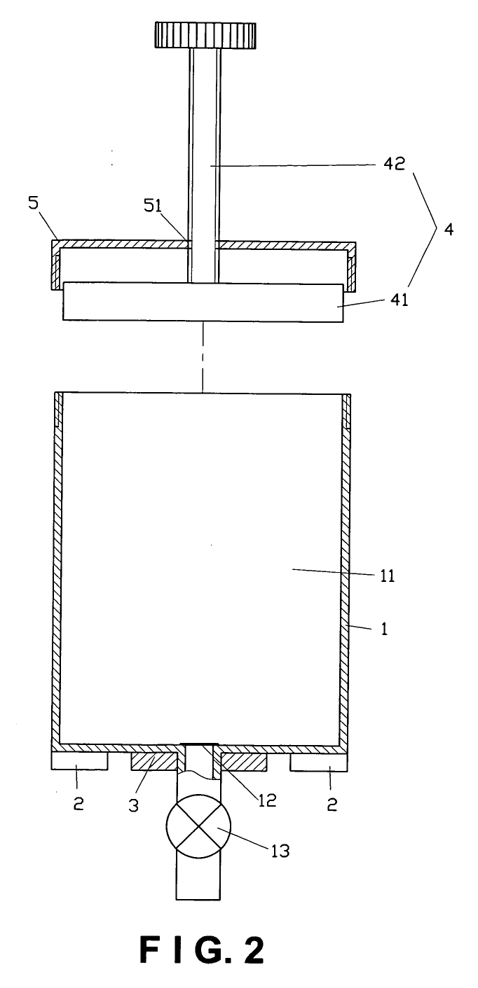

Referring to FIG. 2, the present invention also discloses a preparation device for caffeine control, comprising:

A container (1), provided with a holding space (11) and an outlet (12). The outlet (12) is further fitted with a valve (13).

A vibration unit (2), which in the present embodiment is a plurality of ultrasonic vibrators disposed on an outer edge of the bottom portion of the aforementioned container (1).

A temperature control element (3), which in the present embodiment is an electric heater disposed on an outer edge of the bottom portion of the aforementioned container (1).

A compression element (4), comprising a piston (41) and a screw (42) connected to the piston (41), wherein the shape of the piston (41) corresponds to that of the inner caliber setting of the container (1), thereby enabling a tight fitting of the piston (41) with the inner wall of the container (1). The screw (42) is screw fitted into a cover (5) provided with a screw hole (51), enabling relative movement between the two through screw rotation. The cover (5) covers and seals the aforementioned holding space (11) of the container (1).

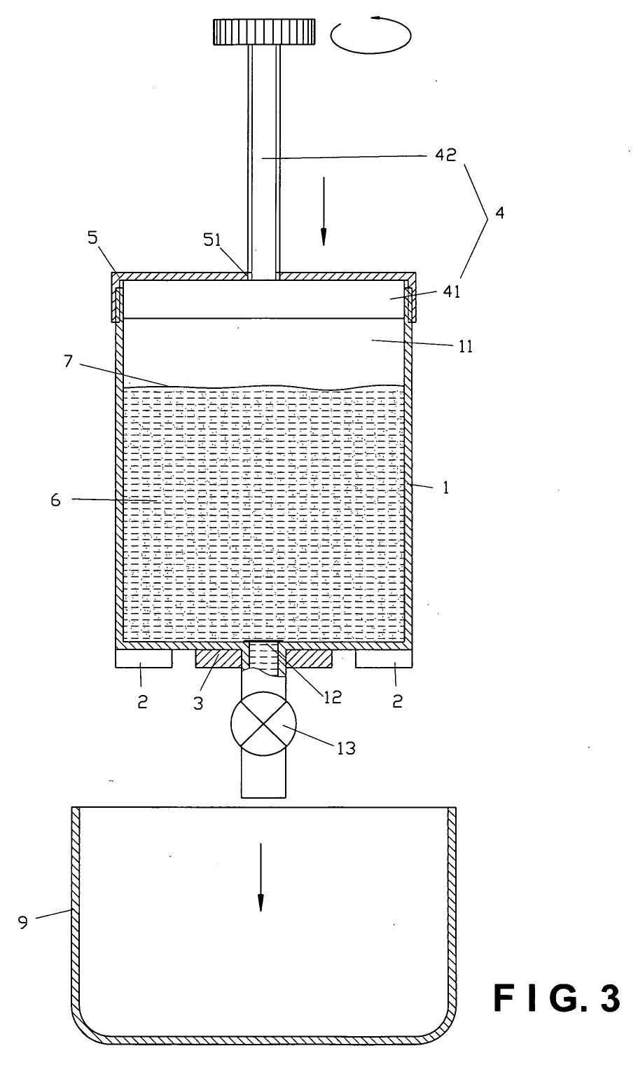

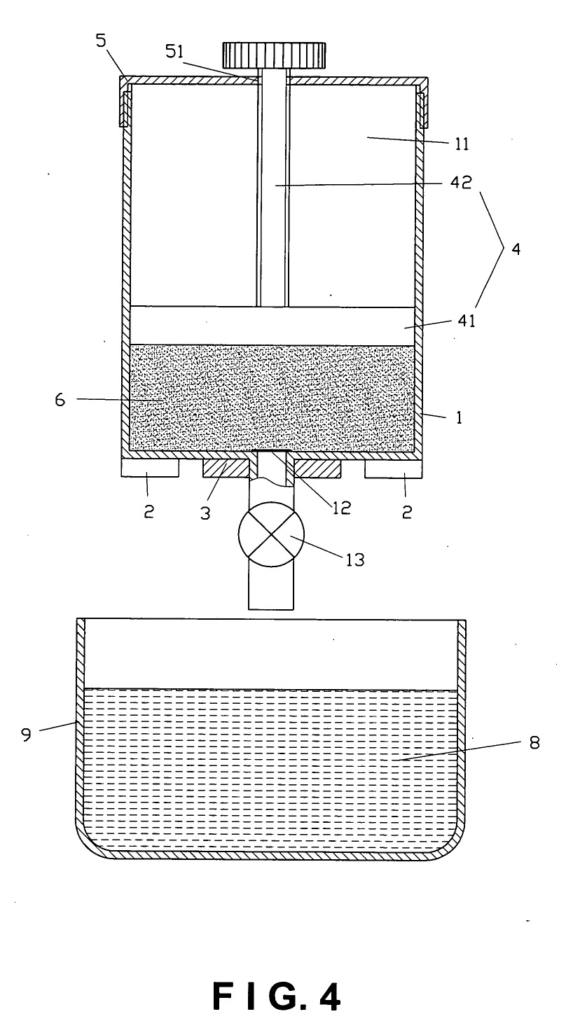

Referring to FIG. 3 and FIG. 4, during implementation, ground coffee (6) and an appropriate proportion of water (7) are mixed in the container (1), and the cover (5) is used to cover the container (1). In the present implementation, the cover (5) is screw fitted to the container (1), at which time the working temperature of the container (1) is maintained at a normal temperature. Subsequently, the vibration unit (2) is used to implement ultrasonic vibration of the container (1), and temperature control is implemented through the temperature control element (3). The present implementation maintains a normal temperature, thereby assisting the extraction process. Afterward, the screw (42) is rotated to force the piston (41) down, thereby contracting the holding space (11) of the container (1) to effect compression, after which the valve (13) of the outlet (12) of the container (1) is opened, thereby enabling compressed extracted liquid (8) to flow out from the outlet (12) and collect within a container (9). Finally, the extracted liquid (8) is heated to 85° C. to complete the operation procedure.

Ultrasonic vibration energy of the aforementioned vibration unit (2) can also be transmitted through other transmission media, such as liquid.

Heat energy of the aforementioned temperature control element (3) can also be transmitted through other transmission media, such as liquid or gas.

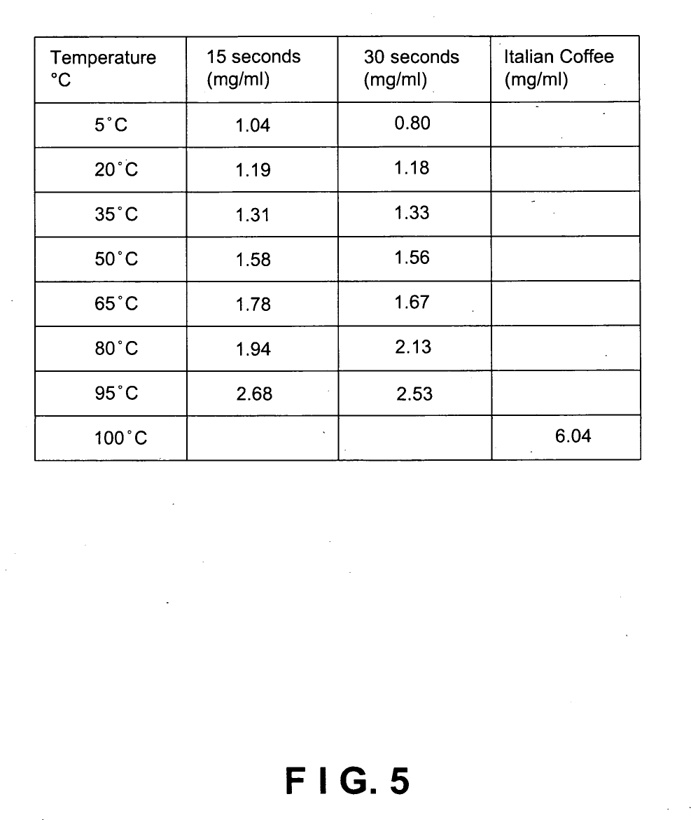

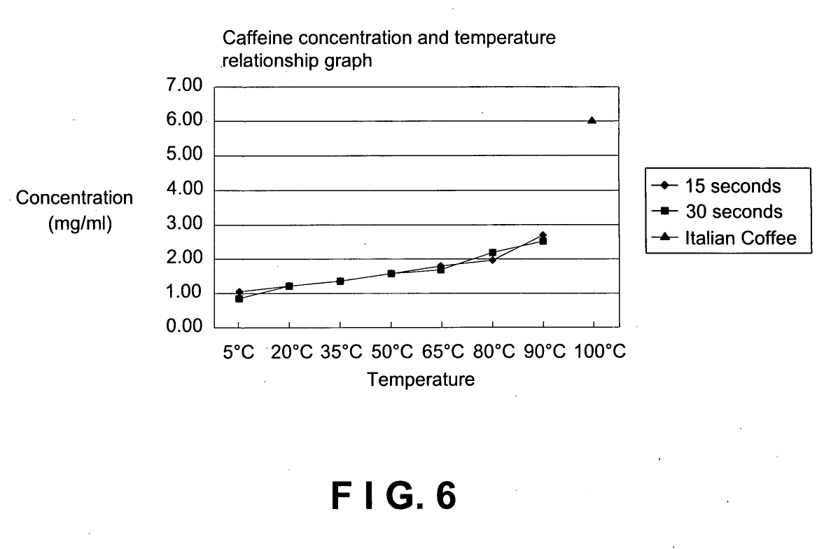

FIG. 5 and FIG. 6 show a difference table and a graph for caffeine extraction amounts for the method of the present invention and a method for traditional high temperature brewed coffee respectively, wherein FIG. 5 shows test results for step b of the present invention separately carried out at different temperatures (5° C. to 95° C.) for a period of 15 seconds and 30 seconds, as well as continuous application of a vibration force during these test periods. The test results indicate that the caffeine concentrations obtained from the coffee liquid when step b is carried out for 15 seconds and 30 seconds are extremely close, thereby signifying that the caffeine concentration in the coffee liquid after 15 seconds has already reached saturation point at the specific working temperature. The test results also indicate that the higher the working temperature at this stage, the higher the caffeine concentration produced after vibration. In addition, the test result indicates that the caffeine concentration of coffee brewed using the method of brewing coffee at the traditional high temperature (100° C.) to directly brew Italian coffee is as high as 6.04 milligrams/milliliters, which, in comparison, clearly exceeds the caffeine concentration obtained with the method of the present invention.

Accordingly, using the present invention and controlling the working temperature of step b enables coffee liquid of different caffeine content to be prepared, whereby controlling the working temperature of step b to be relatively high enables obtaining coffee liquid of high caffeine content; while controlling the working temperature of step b to be relatively low, then coffee liquid of low caffeine content can be obtained. At the same time, incorporating a procedure whereby a vibration force is applied in conjunction with step b enables effectively assisting extracting other effective components (such as aromatic components) in the coffee powder, which, in conjunction with the further heating of step d, enables the coffee liquid to retain a mellow taste and enables controlling the caffeine content.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A preparation method for caffeine control, comprising the following steps:
a. mixing coffee powder and water in a container;
b. applying a vibration force to the container for an acting time, and maintaining the operating temperature during this stage within a first working temperature range;
c. compressing the space within the container to cause specific components in the coffee powder to be extracted and form coffee liquid;
d. heating the coffee liquid obtained from step c to a second working temperature.

2. The preparation method for caffeine control according to claim 1, wherein step a is carried out at a normal temperature.

3. The preparation method for caffeine control according to claim 1, wherein the vibration force of step b is an acting force of ultrasonic vibration frequency.

4. The preparation method for caffeine control according to claim 1, wherein the acting time of step b is 1 to 5 minutes.

5. The preparation method for caffeine control according to claim 1, wherein the first working temperature of step b is between 5 and 60° C. (Celsius).

6. The preparation method for caffeine control according to claim 1, wherein the second working temperature of step d is higher than the first working temperature of step b.

7. The preparation method for caffeine control according to claim 1, wherein the second working temperature of step d is between 80 and 100° C.

8. The preparation method for caffeine control according to claim 1, wherein the second working temperature is 85° C.

9. The preparation method for caffeine control according to claim 7, wherein the second working temperature is 85° C.

10. A preparation device for caffeine control, comprising: a container, provided with a holding space and an outlet, the outlet is further fitted with a valve; a vibration unit, and position of the vibration unit is installed to enable vibration waves to have an effect within the range of the container; a temperature control element, and position of the temperature control element enables heat energy to have an effect within the range of the container; a compression element movable within the container, and used to alter the holding space of the container.

11. The preparation device for caffeine control according to claim 10, wherein the vibration unit is attached to the container.

12. The preparation device for caffeine control according to claim 10, wherein the vibration unit is disposed close to the container, and a vibration wave transmission medium is disposed between the vibration unit and the container, the transmission medium being a liquid.

13. The preparation device for caffeine control according to claim 10, wherein the temperature control element is attached to the container.

14. The preparation device for caffeine control according to claim 10, wherein the temperature control element is disposed close to the container, and a heat energy transmission medium is disposed between the temperature control element and the container, the transmission medium being a liquid.

15. The preparation device for caffeine control according to claim 10, wherein the temperature control element is disposed close to the container, and a heat energy transmission medium is disposed between the temperature control element and the container, the transmission medium being a gas.
